(19) United States
(12) Patent Application Publication
(10) Pub. No.: US 2016/0350656 A1
(43) Pub. Date: Dec. 1, 2016

(54) COGNITIVE AGENT FOR EXECUTING COGNITIVE RULES

(71) Applicant: Omprakash Visvanathan, CHENNAI (IN)

(72) Inventor: Omprakash Visvanathan, CHENNAI (IN)

(21) Appl. No.: 14/748,898

(22) Filed: Jun. 24, 2015

(30) Foreign Application Priority Data
May 25, 2015 (IN) 2600/CHE/2015

(51) Int. Cl. G06N 5/02

(52) U.S. Cl. CPC G06N 5/025

(57) ABSTRACT

The present disclosure relates to a computer-implemented method. The computer-implemented method includes applying a plurality of operations to an initialized state, creating a state graph, executing a plurality of business rules based on the adding of the plurality of nodes and the plurality of attributes to the top level state and updating the state graph. The state is a top level object. The state graph is created by adding a plurality of nodes and a plurality of attributes to a top level state. The state graph is updated to reflect a new state of the state graph. Further, the applying, the creating, the executing and the updating are performed through a plurality of phases.

This application claims the benefit and priority to Indian Application Serial No. 2600/CHE/2015 filed on May 25, 2015, the contents of which are hereby incorporated by reference.

### TECHNICAL FIELD

The present invention relates to the field of business rules, and in particular, relates to methods and systems for executing the business rules by utilizing cognitive systems in a runtime environment.

### BACKGROUND

With an increasing development in the field of artificial intelligence, every domain has started experiencing and/or utilizing capabilities of various artificial intelligence models. Generally, many models based on the concept of artificial intelligent make use of cognition. The cognition refers to human facility of thinking and reasoning. Further, the cognition is an ability of problem solving and decision making Nowadays, the concept of the cognition has been increasingly used to formulate business structure and business rules.

The business rules are intended to assert business structure or to control or influence behavior of a business. Further, as the business rules are closely associated with cognitive systems, the business rules intend to support and/or provide cognitive capabilities. The cognitive capabilities include but may not be limited to problem solving, language comprehension, learning, perception and memory. The cognitive systems use cognitive patterns that are merely recurring templates that humans use during problem solving/reasoning. For example, a condition based operations or maintenance system facilitate decision making such as if and when to perform certain condition based responsive activity, including logistics and maintenance activity in response to a known and/or anticipated condition. Further, the cognitive systems employ various techniques for implementing behavior and decision making capabilities.

In few of presently available cognitive system, human intervention takes over to identify, organize, plan and execute a particular maintenance activity for a given platform or set of platforms. Further, the organizing and the execution of certain conditions are not fully efficient to rely upon. Furthermore, the process becomes time consuming.

In light of the forgoing discussion, there is a need for a method and system that overcomes the above stated disadvantages. Further, there is a need for a method and system that is fully independent of user intervention.

### SUMMARY

In an aspect of the present disclosure, a computer-implemented method is provided. The computer-implemented method includes applying a plurality of operations to an initialized state, creating a state graph, executing a plurality of business rules based on the adding of the plurality of nodes and the plurality of attributes to the top level state and updating the state graph. The state is a top level object. The state graph is created by adding a plurality of nodes and a plurality of attributes to a top level state. The state graph is updated to reflect a new state of the state graph. Further, the applying, the creating, the executing and the updating are performed through a plurality of phases.

In an embodiment of the present disclosure, the computer-implemented method further adds an input link to the initialized state. The input link allows a plurality of users to add one or more elements to a working memory.

In an embodiment of the present disclosure, the computer-implemented method further adds an output link to the initialized state. The output link allows a plurality of business rules to add one or more elements to an output memory.

In an embodiment of the present disclosure, the plurality of phases includes an input phase, an elaboration phase, an operator proposal phase, an operator selection phase, an operator application phase and an output phase.

In an embodiment of the present disclosure, one or more variables are bound to one or more symbols in corresponding one or more elements of a working memory to obtain a production.

In an embodiment of the present disclosure, an action of the production creates a plurality of preferences for selecting one or more operators. Each of the plurality of preferences includes a corresponding semantic of a plurality of semantics. The plurality of preferences includes at least one of an acceptable preference, a reject preference, a better/worse preference, a best preference, a worst preference, an indifferent preference, a numeric-indifferent preference, a require preference and a prohibit preference. Further, a plurality of impasses arises from the plurality of preferences. The plurality of impasses includes a tie impasse, a conflict impasse, a constraint-failure impasse and a no-change impasse. The no-change impasse further includes a state no-change impasse and an operator no-change impasse.

In another embodiment of the present disclosure, an action of the production adds one or more elements in a working memory. The one or more elements being added from at least one of a plurality of sources.

In yet another embodiment of the present disclosure, an action of the production removes one or more elements from a working memory. The one or more elements being removed by at least one of a plurality of removal ways.

In another aspect of the present disclosure, a computer program product includes a non-transitory computer readable medium storing a computer readable program. The computer readable program when executed on a computer causes the computer to perform steps including applying a plurality of operations to an initialized state, creating a state graph, executing a plurality of business rules based on the adding of the plurality of nodes and the plurality of attributes to the top level state and updating the state graph. The state is a top level object. The state graph is created by adding a plurality of nodes and a plurality of attributes to a top level state. The state graph is updated to reflect a new state of the state graph. Further, the applying, the creating, the executing and the updating are performed through a plurality of phases.

In an embodiment of the present disclosure, the computer readable program when executed on the computer causes the computer to perform a further step of adding an input link to the initialized state. The input link allows a plurality of users to add one or more elements to a working memory.

In an embodiment of the present disclosure, the computer readable program when executed on the computer causes the computer to perform a further step of adding an output link to the initialized state. The output link allows a plurality of business rules to add one or more elements to an output memory.

In yet another aspect of the present disclosure, a cognitive agent business rules system is provided. The cognitive agent business rules system includes an application module, a generation module, an execution module and an updation module. The application module applies a plurality of operations to an initialized state. The state is a top level object. The generation module creates a state graph. The state graph is created by adding a plurality of nodes and a plurality of attributes to a top level state. The execution module executes a plurality of business rules based on the adding of the plurality of nodes and the plurality of attributes to the top level state. The updation module updates the state graph. The state graph is updated to reflect a new state of the state graph.

In an embodiment of the present disclosure, the generation module further adds an input link to the initialized state. The input link allows a plurality of users to add one or more elements to a working memory. Further, the generation module adds an output link to the initialized state. The output link allows a plurality of business rules to add one or more elements to an output memory.

In an embodiment of the present disclosure, the cognitive agent business rules system utilizes a Soar component. The Soar component includes one or more views. The one or more views include a trace view, a production view and a goal stack view.

The cognitive agent business rules system of the present disclosure comprising the Soar component to handle one or more events by utilizing SoarEventManager and SoarEventListener interfaces.

In an embodiment of the present disclosure, one or more variables are bound to one or more symbols in corresponding one or more elements of a working memory to obtain a production.

In an embodiment of the present disclosure, an action of the production creates a plurality of preferences for selecting one or more operators. Each of the plurality of preferences includes a corresponding semantic of a plurality of semantics. The plurality of preferences includes at least one of an acceptable preference, a reject preference, a better preference, a best preference, a worst preference, an indifferent preference, a numeric-indifferent preference, a require preference and a prohibit preference.

In an embodiment of the present disclosure, a plurality of impasses arises from the plurality of preferences. The plurality of impasses includes a tie impasse, a conflict impasse, a constraint-failure impasse and a no-change impasse. The no-change impasse includes a state no-change impasse and an operator no-change impasse.

In an embodiment of the present disclosure, an action of the production adds one or more elements in a working memory. The one or more elements are added from at least one of a plurality of sources.

In an embodiment of the present disclosure, an action of the production removes one or more elements from a working memory. The one or more elements being removed by at least one of a plurality of removal ways.

### BRIEF DESCRIPTION OF THE FIGURES

Having thus described the invention in general terms, reference will now be made to the accompanying drawings, which are not necessarily drawn to scale, and wherein:

FIG. 1 illustrates a system for showing interaction of a business rules management system with a communication device, a cloud platform and a data centre, in accordance with various embodiments of the present disclosure;

FIG. 2A illustrates a system showing an interaction between the BRMS, an application server and a plurality of users, in accordance with various embodiments of the present disclosure;

FIG. 2B illustrates an example embodiment of a state graph, in accordance with various embodiments of the present disclosure;

FIG. 2C illustrates another example embodiment of a state graph, in accordance with various embodiment of the present disclosure;

FIG. 3 illustrates a system for showing various phases of a cognitive agent business rules system, in accordance with various embodiment of the present disclosure;

FIG. 4 illustrates a block diagram of a communication device, in accordance with various embodiments of the present disclosure; and

FIG. 5 is a flowchart describing the execution of the plurality of business rules by the cognitive agent business rules system, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

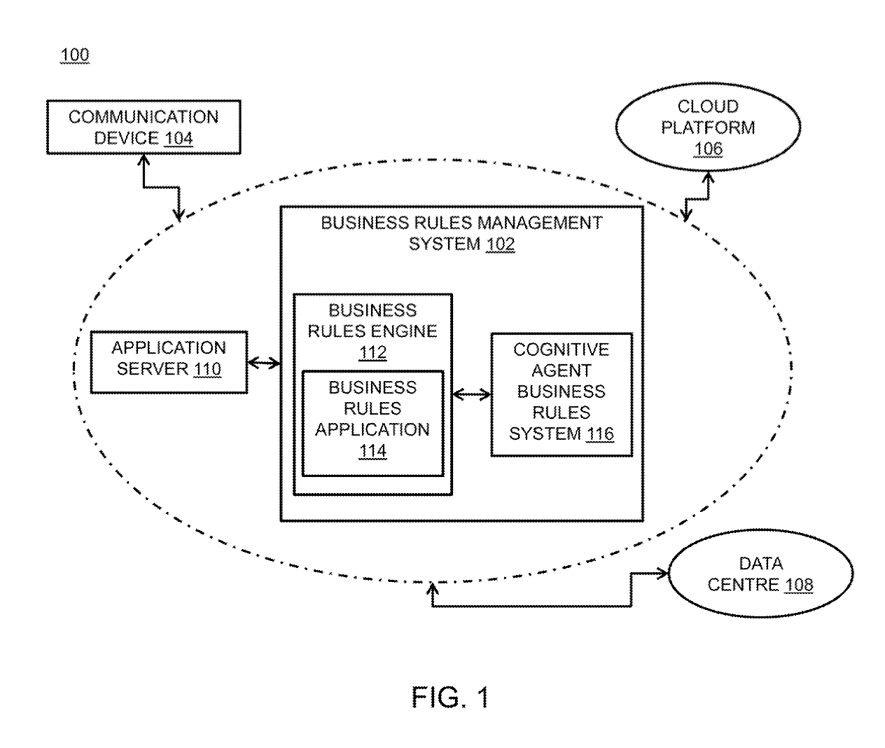

FIG. 1 illustrates a system 100 for showing interaction of a business rules management system 102 with a communication device 104, a cloud platform 106 and a data centre 108, in accordance with various embodiments of the present disclosure. The business rules management system (hereinafter ‘BRMS’) 102 composes business rules and allows individuals and/or users to use its business rules functions. The BRMS 102 is linked to an application server 110. Further, the BRMS 102 hosts a business rules engine 112. Further, the business rules engine 112 hosts a business rules application 114. Essentially, the business rules engine 112 of the BRMS 102 is responsible for composing and managing business rules.

The business rules engine 112 is associated with a cognitive agent business rules system 116. The cognitive agent business rules system 116 emulates and/or supports human cognitive capabilities including problem solving, language comprehension, learning, perception and memory. Further, the cognitive agent business rules system 116 employs various techniques for implementing behavior and decision making capabilities. The application server 110 executes the business rules application 112. The business rules application 114 is available for usage and can be run on the communication device 104, the cloud platform 106 and the data centre 108.

It may be noted that in FIG. 1, the business rules application 114 is run on the communication device 104; however those skilled in the art would appreciate that the business rules application 114 may be run on more communication devices.

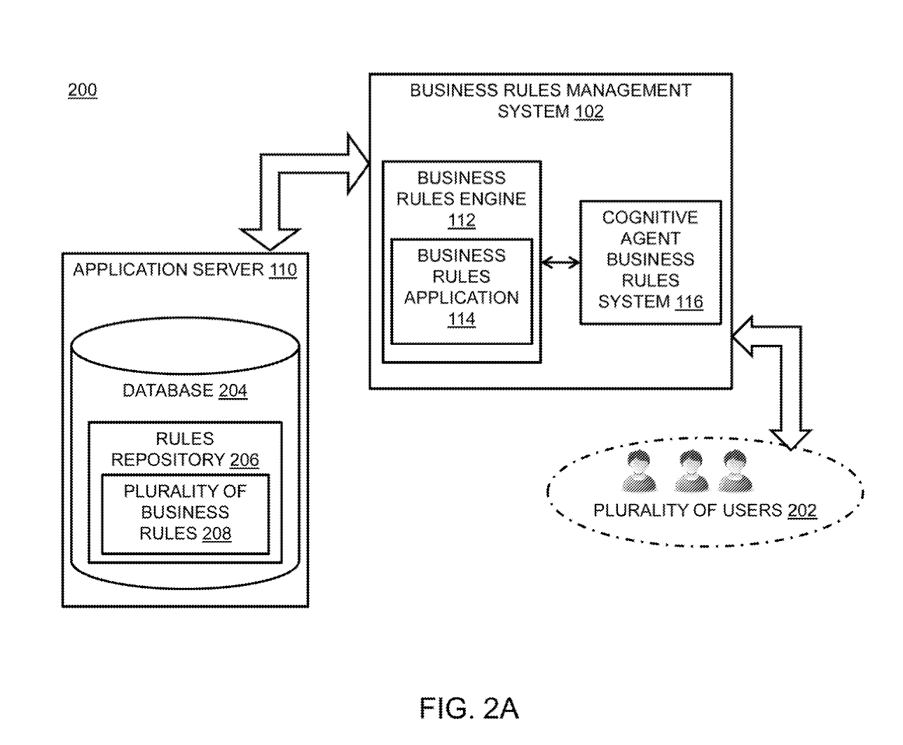

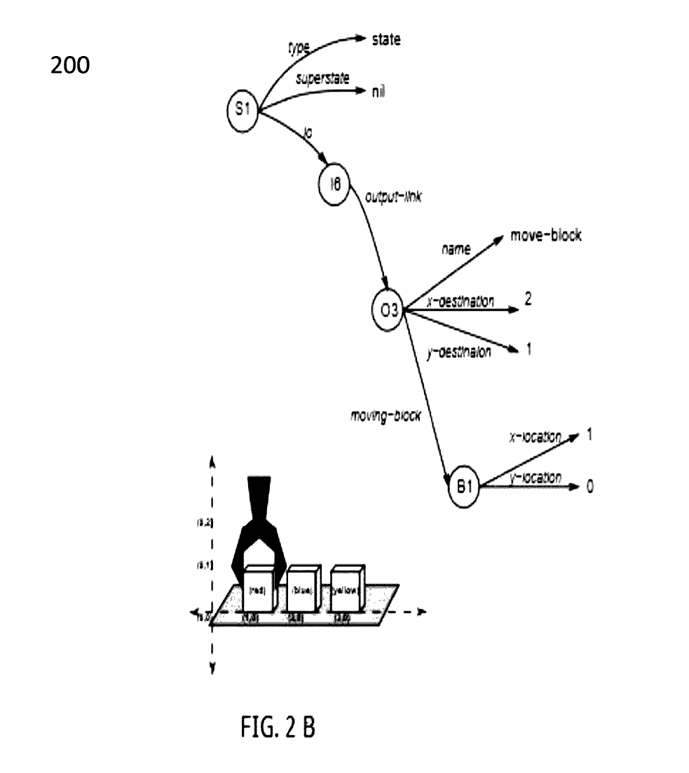

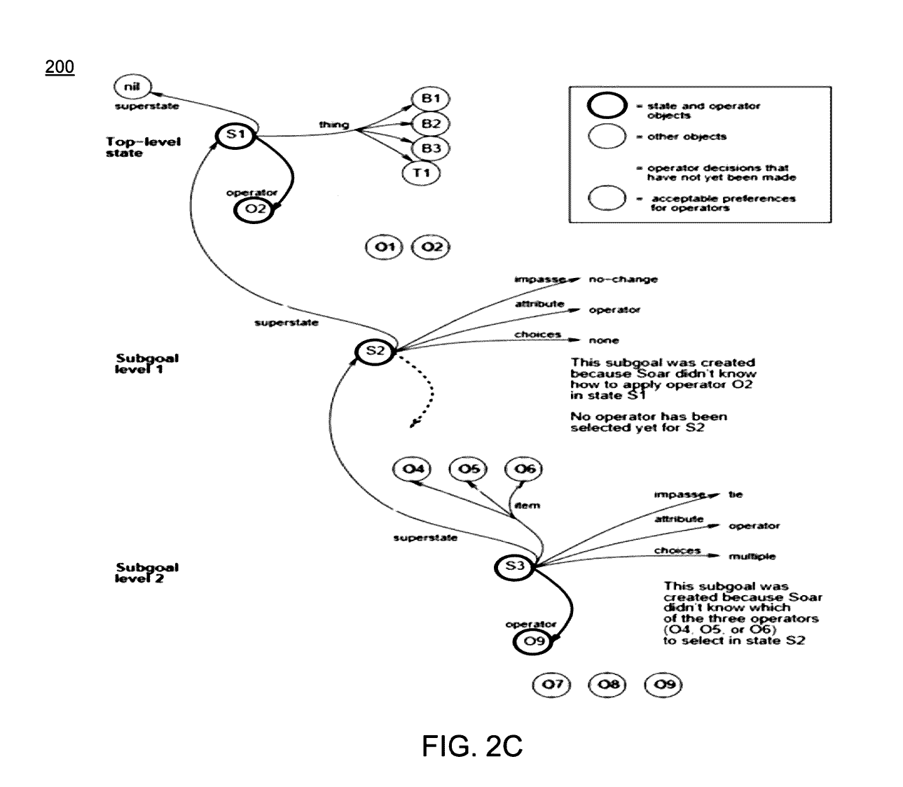

FIG. 2A illustrates a system 200 showing an interaction between the BRMS 102, an application server 110 and a plurality of users 202, in accordance with various embodiments of the present disclosure. The application server 110 includes a database 204. The database 204 stores a rules repository 206. Further, the rules repository 204 stores a plurality of business rules 208.

As described in detailed description of FIG. 1, the business rules engine 112 is associated with the cognitive agent business rules system 116. Thus, the business rules application 114 of the business rules engine 112 can run cognitive tasks to solve real world problems. The cognitive agent business rules system 116 manages the cognitive tasks by initializing a state and applying a plurality of operations to the initialized state. Generally, the state is a top level object that refers to a psychology concept of ‘state of being’. For example, every object is in some state including stationary, moving, sitting, standing and the like. Also, when a sitting object stands, its state changes from sitting to standing.

In an embodiment of the present disclosure, the cognitive business rules engine of the present invention utilizes a Soar component. Soar, is a general cognitive architecture for developing systems that exhibit intelligent behavior. As will be understood from the following description, the Soar component of the present disclosure also encompasses technical elements from JSoar (a Java implementation of Soar), CSoar's SWIG-generated bindings, Soar SML etc. in order to overcome several shortcomings inherent in the art, thereby ensuring cleaner integration in enterprisey systems, multiple language support, eliminating the need for native libraries and the like.

In an embodiment of the present disclosure, the Soar component of the cognitive business rules engine of the present invention includes a centralized event system with which listeners can be registered and events can be received. Important interfaces are SoarEventManager and SoarEventListener. Client code implements the SoarEventListener interface and registers with the SoarEventManager, which is accessible through agent.getEvents( ).

Further, the cognitive agent business rules system 116 creates a state graph. The state graph is created by adding a plurality of nodes and a plurality of attributes to a top level state. Furthermore, the cognitive agent business rules system 116 executes a plurality of business rules based on the adding of the plurality of nodes and the plurality of attributes to the top level state. The plurality of business rules are composed and formulated by the business rules engine 112. In addition, the cognitive agent business rules system 116 updates the state graph. The state graph is updated to reflect a new state of the state graph. Moreover, the cognitive agent business rules system 116 adds an input link to the initialized state. The input link is configured to allow a plurality of users to add one or more elements to a working memory. The cognitive agent business rules system 116 adds an output link to the initialized state. The output link is configured to allow the plurality of business rules 208 to add the one or more elements to an output memory. In simpler terms, the plurality of users 202 can add the one or more elements to the working memory via the input link. The business rules add the one or more elements to the output memory to let each of the plurality of users 202 know of changes or result. The cognitive agent business rules system 116 uses SoarBeans for registering an output command handler with SoarBeanOutputManager.

Further, the cognitive agent business rules system 116 includes a plurality of phases. The plurality of phases includes an input phase, an elaboration phase, an operator proposal phase, an operator selection phase, an operator application phase and an output phase. The cognitive agent business rules system 116 scans the one or more elements added to the input link during the input phase and writes the one or more elements to the output link in the output phase. Each time during the input phase, an InputEvent is fired. Further, during this event, it is safe to modify the input-link. Moreover, one or more helper methods are provided for creating both symbols and input working memory elements. These one or more helper methods reside in Symbols and InputWmes.

The elaboration phase runs the plurality of business rules 208 and adds elaborations or deduced facts to the state graph. Once candidate paths have been chosen, one or more operators are proposed. The one or more operators run and make changes to the state or the output link causing more rules of the plurality of business rules 208 to execute. The above phases loop continuously, or in other words, the plurality of phases can run for a specific number of cycles, run once and then stop.

In an embodiment, the cognitive agent business rules system 116 uses a two stage process to the one or more operators. The operator proposal phase of the cognitive agent business rules system 116 proposes the one or more operators to run. The operator selection phase selects a correct operator of the one or more operators to run and the operator application phase runs the correct operator and applies changes. In this way, a best operator for a given situation can be selected from the one or more operators. The output phase displays the selected operator. For example, in a maze program, a robot could encounter 3 paths Left, straight ahead or right ahead of it and must decide which path to choose for which 3 operators are proposed. Further, the operator proposal rule proposes the correct operator with a preference strategy. The cognitive agent business rules system 116, then, selects the correct operator and applies it.

Further, in the cognitive agent business rules system 116, one or more variables are bound to one or more symbols in the corresponding one or more elements of the working memory to obtain a production. Furthermore, the binding is performed by a matching process. The production along with a specific and consistent set of variable bindings is referred to as an instantiation. The production instantiations are consistent as every occurrence of a variable is bound to the same value. In an embodiment of the present disclosure, in the cognitive agent business rules system 116, several instantiations of same production may be matched at a same time and, therefore, fired at the same time.

In an embodiment of the present disclosure, the one or more variables are used to test for identifiers and using the same variables across multiple occurrences links conditions together. Further, the one or more elements of the working memory are linked to the state in the working memory and even to objects referred to in a production's conditions. In simpler terms, one condition tests the state object and all other conditions also test that same state or objects that are linked to that state.

In an embodiment of the present disclosure, in the cognitive agent business rules system 116, an action of the production creates a plurality of preferences for selecting the one or more operators. The plurality of preferences persists only as long as the production instantiation that created the plurality of preferences continues to match. When the production instantiation no longer matches, a preference of the plurality of preference is no longer relevant. In this case, the cognitive agent business rules system 116 automatically removes the preference. The plurality of preferences has an I-support (for instantiation support). In an embodiment, the state elaborations are simple inferences that are valid only so long as the production matches.

In another embodiment of the present disclosure, in the cognitive agent business rules system 116, an action of the production adds the one or more elements in the working memory. The one or more elements are added from at least one of a plurality of sources (described later). In yet another embodiment of the present disclosure, in the cognitive agent business rules system 116, an action of the production removes the one or more elements from the working memory. The one or more elements are removed from at least one of a plurality of removal ways (described later). In the cognitive agent business rules system 116, the actions of the productions that apply to an operator of the one or more operators, either by adding or removing the one or more elements from the working memory, persist even after the operator is no longer selected and operator application production instantiation no longer matches.

Further, in the cognitive agent business rules system 116, the selection of the current operator is determined by the plurality of preferences in a preference memory. Each of the plurality of preferences is a suggestion or an imperative about a current operator, or information about how suggested operators compare to other operators. Furthermore, each of the plurality of preferences refers to the one or more operators by using the identifier of the one or more elements of the working memory that stands for the operator. After preferences have been created for the state, a decision procedure evaluates the created preferences to select the current operator for that state.

Furthermore, each of the plurality of preferences includes a corresponding semantic of a plurality of semantics. Moreover, the plurality of preferences includes at least one of an acceptable preference, a reject preference, a better/worse preference, a best preference, a worst preference, an indifferent preference, a numeric-indifferent preference, a require preference and a prohibit preference. The plurality of semantics for each of the plurality of preferences is described below:

A semantic for the acceptable preference is Acceptable (+). The acceptable preference states that a value is a candidate for a selection. A semantic for the reject preference is Reject (−). The reject preference states that the value is not a candidate for a selection. A semantic for the better/worse preference is Better (>), Worse (<). The better/worse preference states, for a two values involved, that one value should not be selected if the other value is a candidate. A semantic for the best preference is Best (>). The best preference states that a value may be better than any competing value. A semantic for the worst preference is Worst (<). The worst preference states that a value should be selected only if there are no alternatives. A semantic for the indifferent preference is Indifferent (=). The indifferent preference states that there is a positive knowledge that it does not matter which value is selected. A semantic for the numeric-indifferent preference is Numeric-Indifferent: (=number). The numeric-indifferent preference is used to bias a random selection from mutually indifferent values. A semantic for the require preference is Require (!). The require preference states that a value must be selected if a goal is to be achieved. A semantic for the prohibit preference is Prohibit (˜). The prohibit preference states that a value cannot be selected if a goal is to be achieved.

In the cognitive agent business rules system 116, when the preference of the plurality of preferences in the preference memory cannot be resolved unambiguously, the cognitive agent business rules system 116 reaches an impasse. Further, when the cognitive agent business rules system 116 is unable to select a new operator (in the decision cycle), it is said to reach an operator impasse. In the cognitive agent business rules system 116, all the impasses appear as the states in the working memory, where the states can be tested by productions.

In the cognitive agent business rules system 116, a plurality of impasses arises from the plurality of preferences. In an embodiment of the present disclosure, the plurality of impasses is four in number. The plurality of impasses includes a tie impasse, a conflict impasse, a constraint-failure impasse and a no-change impasse. Further, the no-change impasse comprises a state no-change impasse and an operator no-change impasse. The tie impasse arises if the preference of the plurality of preferences does not distinguish between two or more operators with acceptable preferences. The conflict impasse arises if at least two values have conflicting better or worse preferences (for example, A is better than B and B is better than A) for an operator, and neither one is rejected, prohibited, or required. The constraint-failure impasse arises if there is more than one required value for an operator, or if a value has both a ‘require’ and a ‘prohibit’ preference. The no-change impasse arises if a new operator is not selected during a decision procedure. Further, there are two types of no-change impasse. The first is the state no-change impasse which occurs when there are no acceptable (or require) preferences to suggest operators for the current state (or all the acceptable values have also been rejected). The decision procedure cannot select a new operator. The second is the operator no-change impasse which occurs when either a new operator is selected for the current state but no additional productions match during the application phase, or a new operator is not selected during the next decision phase. In an embodiment, there can be only one type of impasse at a given level of sub-goaling at a time.

The cognitive agent business rules system 116 handles the plurality of impasses by creating a new state in which a goal of the problem solving is to resolve the impasse of the plurality of impasses. Thus, in a sub-state, the one or more operators are selected and applied in an attempt either to discover which of the tied operators should be selected, or to apply the selected operator piece by piece. The sub-state is often referred to as a sub-goal because it exists to resolve the impasse of the plurality of impasses. However, it sometimes referred to a sub-state because representation of the sub-goal is referred as the state.

In the cognitive agent business rules system 116, the sub-goals created to resolve the plurality of impasses generate results that allow the problem solving at higher levels to proceed. Results of the sub-goal are the working memory elements and the plurality of preferences that were created in the sub-state, and that are linked directly or indirectly to a super-state (any super-state in the stack). Architecture of the cognitive agent business rules system 116 automatically detects if the preference or the one or more elements of the working memory created in the sub-state is linked to the super-state. In cognitive agent business rules system 116, the one or more elements of the working memory and the plurality of preferences will not be removed when the impasse of the plurality of impasses is resolved as it is still linked to a super-state, and therefore are the results of the sub-goal. The cognitive agent business rules system 116 decides if a result has either I-support or O-support as follows:

In an embodiment of the present disclosure, a one or more element of the working memory or the preference of the plurality of preferences will be a result if the identifier is already linked to a super-state. These preferences are said to have I support (instantiation support). Working memory elements created as state elaborations also have I-support and remain in working memory only as long as the production instantiation that created them continues to match working memory. For example, the set of relevant operators changes as the state changes, thus the proposal of operators is done with I-supported preferences. In another embodiment of the present disclosure, a one or more element of the working memory or the preference of the plurality of preferences will be a result indirectly if, after it is created and still in the working memory or the preference memory, the identifier becomes linked to a super-state through a creation of another result.

However, the actions of productions that apply an operator, either by adding or removing elements from working memory, need to persist even after the operator is no longer selected and operator application production instantiation no longer matches. For example, in placing a block on another block, a condition is that the second block be clear. However, the action of placing the first block removes the fact that the second block is clear, so the condition will no longer be satisfied. Thus, operator application productions do not retract their actions, even if they no longer match working memory. This is called O-support (stands for operator support).

Working memory elements that participate in the application of operators are maintained throughout the existence of the state in which the operator is applied, unless explicitly removed (or if they become unlinked). Working memory elements are removed by a reject action of a operator application rule.

In the cognitive agent business rules system 116, some sub-goal results receive the I-support, while others receive the O-support. Type of the support received by the result is determined by a function it plays in the super-state, and not a function it played in the state in which it was created. For example, a result might be created through operator application in the state that created it; however, it might only be a state elaboration in the super-state. The first function would lead to the O-support, but the second would lead to the I-support.

In an embodiment of the present disclosure, for determine whether the result receives the I-support or the O-support, the cognitive agent business rules system 116 determines the function that the one or more element of the working memory or the preference of the plurality of preferences plays. In simpler terms, it determines whether the result should be considered an operator application or not). To do this, the cognitive agent business rules system 116 creates a temporary production, referred to as a justification. The justification summarizes the processing in the sub-state that led to the result.

Further, conditions of the justification are the one or more elements of the working memory that exist in the super-state (and above) and that were necessary for producing the result. This is determined by collecting the entire one or more elements of the working memory that were tested by the productions and fired in the sub-goal that led to creation of the result, and then removing the conditions that test working memory elements created in the sub-goal. The action of the justification is the result of the sub-goal.

In an embodiment, the cognitive agent business rules system 116 determines the I-support or the O-support for the justification just as it would for any other production. If the justification is an operator application, the result will receive the O-support. Otherwise, the result gets the I-support from the justification. If the result loses the I-support from the justification, it will be retracted if there is no other support. The justification is not added to the production memory, but are otherwise treated as an instantiated production that has already fired. In an embodiment, the justifications include any negated conditions that were in original productions, participated in producing the results, and tested for the absence of super-state element of the working memory.

Further, in the cognitive agent business rules system 116, an impasse of the plurality of impasses is regenerated when the problem solving in a sub-goal becomes inconsistent with a current situation. During problem solving in the sub-goal, the cognitive agent business rules system 116 monitors an aspect of the surrounding situation (the one or more elements of the working memory that exist in super-states) problem solving in the sub-goal has depended upon. If those aspects of the surrounding situation change, either because of changes in input or because of results, the problem solving in the sub-goal is inconsistent, and the state created in response to the impasse is removed and a new state is created. The problem solving continues from this new state. The impasse is not resolved, and the cognitive agent business rules system 116 does not learn in this situation.

In the cognitive agent business rules system 116, in case of multiple sub-states, a cycle followed by the cognitive agent business rules system 116 remains same as when there are no sub-states but has a plurality of changes. The plurality of changes includes a first change and a second change. The first change is that during the decision procedure, the cognitive agent business rules system 116 detects the plurality of impasses and creates new sub-states. The second change when there are multiple sub-states at each phase, the cognitive agent business rules system 116 goes through each of the sub-states, from oldest (highest) to newest (lowest), completing any necessary processing at that level for that phase before performing any processing in the next sub-state. In an embodiment, during firing of the production for the proposal or application phases, the cognitive agent business rules system 116 processes the firing (and retraction) of rules, starting from those matching an oldest sub-state to a newest. Further, whenever a production fires or retracts, changes are made to the working memory and the preference memory, possibly changing which productions will match at lower levels. Further, productions firing within a given level are fired in parallel to each other. The productions firings at higher levels resolves the plurality of impasses, thereby eliminate lower states before the productions at the lower level ever fire. Thus, whenever a level in the state stack is reached, all production activity is guaranteed to be consistent with any processing that has occurred at higher levels.

In an embodiment of the present disclosure, the cognitive agent business rules system 116 is capable of learning from experience. A learning mechanism of the cognitive agent business rules system 116 is referred to as chunking. In the chunking, the cognitive agent business rules system 116 creates a new production, called a chunk. Conditions of the chunk are the one or more elements of the state that allowed the plurality of impasses to be resolved; the action of the production is the one or more elements of the working memory or the plurality of preferences that resolved each of the plurality of impasses. The conditions and the action are variablized for matching a new production in a similar situation in future and prevent an impasse from arising

In an embodiment of the present disclosure, the cognitive agent business rules system 116 represents the current problem-solving situation in the working memory. Thus, the working memory holds the current state and the one or more operators and is a short-term knowledge, that reflects the current knowledge of the world and status in the problem solving. The one or more elements in the working memory are referred to as working memory elements (hereinafter ‘WME’). Each WME contains a very specific piece of information; for example, a WME might say that “B1 is a block”. Several WME's collectively may provide more information about a same object, for example, “B1 is a block”, “B1 is named A”, “B1 is on the table”, and the like. These WME's are related as these WME's are all contributing to a description of something that is internally known to the cognitive agent business rules system 116 as “B1”. Further, the B1 is referred to as an identifier and a group of WME's that share this identifier are referred to as the object in the working memory. In cognitive agent business rules system 116, the objects in the working memory are linked to other objects. Further, value of one WME may be an identifier of another object. For example, a WME might say that “B1 is on top of T1”, and another collection of WME's might describe the object T1 as “T1 is a table”, “T1 is brown”, and “T1 is on top of F1”. Further, yet another collection of WME's might describe an object F1 as “F1 is a floor” and the like. In the cognitive agent business rules system 116, all objects in the working memory must be linked to the state, either directly or indirectly (through other objects). Further, objects that are not linked to the state will be automatically removed from the working memory by the architecture of the cognitive agent business rules system 116.

Further, a key concept of the cognitive agent business rules system 116 is that the working memory is a set, meaning that there can never be two elements in the working memory at the same time having a same identifier-attribute value triple. However, it is possible to have multiple working memory elements that have the same identifier and attribute, however each have different values thus forming a multi-attribute. Moreover, the one or more elements in the working memory arise from the plurality of sources. The plurality of sources includes a first source, a second source, a third source and a fourth source. The first source describes that the actions of productions create most of the working memory elements. The second source describes that the decision procedure automatically creates some special state augmentations (for example, type, the super-state, the plurality of impasses and the like) whenever the state is created. The states are created during an initialization (the first state) or due to the impasse (the sub-state). The third source describes that the decision procedure creates an operator augmentation of the state based on the plurality of preferences. This records the selection of the current operator. The fourth source describes that external I/O systems create the working memory elements on the input-link for sensory data.

Further, in the cognitive agent business rules system 116, the one or more elements in working memory are removed by a plurality of removal ways. The plurality of removal ways includes a first way, a second way, a third way, a fourth way, a fifth way and a sixth way. According to the first way, the decision procedure automatically removes all state augmentations it creates when the impasse that led to their creation is resolved. According to the second way, the decision procedure removes the operator augmentation of the state when that operator is no longer selected as the current operator. According to the third way, the actions of the production that uses reject preferences remove working memory elements that were created by other productions. According to the fourth way, the architecture of the cognitive agent business rules system 116 automatically removes the I-supported WMEs when the productions that created them no longer match. According to the fifth way, an I/O system removes sensory data from the input-link when it is no longer valid. According to the sixth way, the architecture of the cognitive agent business rules system 116 automatically removes the WME's that are no longer linked to the state.

Further, the cognitive agent business rules system 116 distinguishes between two types of working memory symbols. The two types of working memory symbols include identifiers and constants. The identifier is a unique symbol, created at runtime when a new object is added to the working memory. Names of identifiers are created by Soar, and include a single uppercase letter followed by a string of digits, for example, G37 or O22. Further, there are three types of constants including integers, floating-point, and symbolic constants. For the integers, a range of values depends on the machine and implementation. For the floating-point, range depends on machine and implementation. The symbolic statements are symbols with arbitrary names. A constant can use any combination of letters, digits, special symbols and the like. Further, characters including blank spaces can be included by surrounding the complete constant name with vertical bars.

In the cognitive agent business rules system 116, all the WME's that share an identifier are collectively referred to as the object in the working memory. Further, individual working memory elements that make up the object are referred to as augmentations, as they augment the object. A template for the object in the working memory of the cognitive agent business rules system 116 is described below:

(identifier ̂attribute-1 value-1 ̂attribute-2 value-2 ̂attribute-3 value-3 . . . ̂attribute-n value-n)

For example, the one or more elements in the working memory when running a program may be as follows:

(S1 ̂io I1 ̂ontop O2 ̂ontop O3 ̂ontop O1 ̂problem-space blocks ̂superstate nil ̂thing B3 ̂thing T1 ̂thing B1 ̂thing B2 ̂type state)

In the cognitive agent business rules system 116, when the working memory element is created, the cognitive agent business rules system 116 assigns it a unique integer timetag. The timetag is a part of the working memory element, and therefore, WME's are referred to as quadruples, rather than triples. However, the timetags are not represented in the working memory and cannot be matched by productions. Further, the timetags are used to distinguish between one or more occurrences of the same WME. As the preference changes and elements are added and deleted from the working memory, the WME can be created, removed, and created again. In an embodiment, a second creation of the WME which bears a same identifier, attribute, and value as a first WME is different, and therefore is assigned a different timetag. This is important as a production fires only once for a given instantiation, and the instantiation is determined by timetags that match the production and not by the identifier-attribute-value triples.

In the cognitive agent business rules system 116, the acceptable preferences for the operator augmentations of the states appear in the working memory as the identifier-attribute-value-preference quadruples. No other preferences appear in the working memory. A template for an acceptable preference in working memory is:

(identifier ̂operator value+)

In the cognitive agent business rules system 116, the working memory is not only a set, it is also a graph structure where the identifiers are nodes, the attributes are links, and the constants are terminal nodes. The working memory is not an arbitrary graph, but a graph rooted in the states. Further, all the WMEs are linked either directly or indirectly to the state. An impact of this constraint is that all the WMEs created by the actions are linked to the WMEs tested in the conditions. The link is one-way, from the identifier to the value.

A long term memory of the cognitive agent business rules system 116 is referred to as production memory. The production memory includes productions or rules, which can be loaded in by a use or generated by the chunking. Further, each of the production has three required components including a name, a set of conditions (referred to as left-hand side, or LHS), and a set of actions (referred to as right-hand side, or RHS). Further, there are two optional components including a documentation string and a type. Syntactically, each of the production includes a symbol sp, followed by an opening curly brace (‘{’), a production name, a documentation string (optional), a production type (optional), one or more comments (optional), one or more production conditions, a symbol --> (literally-dashdash-greaterthan), one or more production's actions; and a closing curly brace (T). Each element of a production is separated by white space. A syntax representing the above statements are:

sp {production-name Documentation string:type CONDITIONS-->ACTIONS}

In the cognitive agent business rules system 116, the name of the production is an almost arbitrary constant. Conventionally, the name of the production describes a role of the production; however functionally, the name is just a label primarily for the use of the programmer. In an embodiment of the present disclosure, the production name can never be a single letter followed by numbers. Further, a convention for naming productions is to separate important elements with asterisks. The important elements that tend to appear in the name include a name of the task or goal (for example, blocks-world), a name of an architectural function (for example, propose), a name of the operator (or other object) at issue. (for example, move-block) and any other relevant details.

In the cognitive agent business rules system 116, the production may contain an optional documentation string. A syntax for the documentation string is that it is enclosed in double quotes and appears after the name of the production and before a first condition (and may carry over to multiple lines). The documentation string allows an inclusion of internal documentation about the production. The production may also include an optional production type, which may specify that the production should be considered a default production (:default) or a chunk (:chunk), or may specify that a production should be given the O-support (O-support) or the I-support (:i-support). There is an additional flag (:interrupt) that can be placed at this location in the production. However, this flag does not specify the production type, but is a signal that the production should be marked for special debugging capabilities. Further, the productions may contain single line comments which begin with a #.

In the cognitive agent business rules system 116, a condition side of the production includes a set of conditions. Each of the condition tests for the existence or absence of the working memory elements. Further each of the condition includes an open parenthesis, followed by a test for the identifier, and the tests for the augmentations of that identifier, in terms of attributes and values. Moreover, the condition is terminated with a close parenthesis. Thus, a single condition might test properties of the one or more working memory elements that constitute the object. The single condition is described as follows:

(identifier-test ̂attribute1-test value1-test ̂attribute2-test value2-test ̂attribute3-test value3-test)

The first condition in a production must match against the state in the working memory. Further, the first condition must begin with an additional symbol state. All other conditions and actions must be linked directly or indirectly to this condition. In the cognitive agent business rules system 116, variables match against constants in the working memory elements in the identifier, the attribute, or value positions.

In the cognitive agent business rules system 116, in an embodiment of the present disclosure, a test for the identifier, the attribute, or the value in the condition (whether constant or variable) can be modified by a preceding predicate. In an embodiment, number of predicates that can be used are six in number including < >, <=>, <, <=, >= and >. In the cognitive agent business rules system 116, in another embodiment of the present disclosure, a test for the identifier, the attribute, or the value may be for a disjunction of constants. With the disjunction, there is a match if any one of the constants is found in the working memory element (and the other parts of the working memory element matches). Further, variables and the predicates may not be used within disjunctive tests. For example, a third condition of a production contains a disjunction that restricts a color of table to red or blue as follows:

sp {blocks*example-production-conditions (state ̂operator <o>+̂table <t>) (<o>̂name move-block) (<t>̂type table ̂color <<red blue >>)-->}

In the cognitive agent business rules system 116, in yet another embodiment of the present disclosure, a test for the identifier, the attribute, or the value in a condition may include a conjunction of tests, all of which must hold for there to be a match. Syntactically, conjuncts are contained within curly braces.

Further, in an addition to positive tests for the one or more elements in the working memory, conditions can also test for an absence of one or more patterns. Moreover, a negated condition is matched only if there does not exist a working memory element which is consistent with its tests and variable bindings. Thus, it is a test for the absence of the working memory element. Further, in the cognitive agent business rules system 116, conditions can be grouped into one or more conjunctive sets by surrounding the set of conditions with ‘{’ and ‘}’. The production compiler groups the test in these conditions together. This grouping allows for negated tests of more than one working memory element at a time. In the example below, the state is tested to ensure that it does not have the object on the table:

sp {blocks*negated-conjunction-example (state <s>̂name top-state)-{(<s>̂ontop<on>) (<on>̂bottom-object <bo>) (<bo>̂type table)}-->(<s>̂nothing-ontop-table true)}

In an embodiment of the present disclosure, the cognitive agent business rules system 116, particularly the Soar component includes a graphical debugger implemented directly with the JSoar Java API and Swing. The graphical debugger includes one or more views, each of which is a separate dockable window within the overall debugger window. The one or more views include trace view, production view and goal stack view. The trace view shows traditional trace of the execution. Further, the trace view shows output of commands executed. The production view shows a list of all production rules currently loaded. The list can be filtered with a regex. The goal stack view shows the current goal stack including currently selected operators if any.

In an embodiment of the present disclosure, the Soar component uses a web-based debugging interface referred to as Legilimens. Once enabled, it starts a lightweight web server through for monitoring and debugging. Further, the Legilimens can be used to View the agent trace, execute commands, view and edit production, inspect working memory and the like. In an embodiment of the present disclosure, the JSoar includes a plurality of RHS functions including debug, wait, get-url <url>, to-xml <id>, from-xml <xml> and split <string> <regex>. The debug opens a debugger for an agent. The wait causes the agent's thread to sleep until new input is available. The get-url <url> retrieves the contents of a given URL (a string) and return it as a string. The to-xml <id> converts the working memory under a given id into XML and returns it as a string. The from-xml <xml> converts the given XML string to working memory and returns an identifier. The split <string> <regex> splits a string with a given regular expression and returns a linked-list of strings.

In accordance with FIG. 2B, an exemplary embodiment of the state graph for selecting the operator is described herein. The cognitive agent business rules system 116 initializes a state S1 for running the cognitive tasks. The state S1 is a top level state and the plurality of nodes and the plurality of attributes are added to the state S1. Further, objects B1, B2, B3 and T1 are other objects associated with the state S1. Moreover, there is no superstate associated with the state S1. In an embodiment of the present disclosure, the plurality of nodes and the plurality of attributes are added to the state S1 for the creation of the state graph. Furthermore, the state S1 includes the input link and the output link (as described above in the detailed description of FIG. 2A). The cognitive agent business rules system 116 scans the element added to the working memory via the input link associated with the state S1.

FIG. 2C illustrates another example embodiment of the state graph for selecting the operator, in accordance with the various embodiments of the present disclosure. The example embodiment shows the creation of the state graph based on the operator selection for executing the particular business rules of the plurality of business rules for a business process. In an embodiment of the present disclosure, the plurality of business rules is executed based on the creation of the state graph. Moreover, the state graph shows the creation of new subgoals or substates due to the event of the impasse. In an embodiment of the present disclosure, the state graph aids in resolving the impasse arised due to no operator selection by the top level object.

In addition, a plurality of phases is associated with the state S1 for execution of the business rule of the plurality of business rules. The state S1 is associated with a plurality of operators including a first operator O1 and a second operator O2. Moreover, an operator of the first operator O1 and the second operator O2 is chosen by the cognitive agent business rules system 116 for executing the business rule. The cognitive agent business rules system 116 selects the operator of the first operator O1 and the second operator O2 from among the plurality of operators based on an operator selection process and runs the operator and applies changes to the state S1 caused by the selection of the operator (as described above in the detailed description of FIG. 2B).

Going further, the selection of the operator for the state S1 is determined by the plurality of preferences in the preference memory. The creation of the preferences for the state S1 is followed by an evaluation for selection of a current operator for the state S1. Furthermore, each of the plurality of preferences includes the corresponding semantic of the plurality of semantics. Moreover, the plurality of preferences includes at least one of the acceptable preference, the reject preference, the better/worse preference, the best preference, the worst preference, the indifferent preference, the numeric-indifferent preference, the required preference and the prohibit preference (as described above in the detailed description of FIG. 2B).

In an embodiment of the present disclosure, the preferences for selecting the operator for the state S1 cannot be solved unambiguously, leading to the event of the impasse. In an embodiment of the present disclosure, the second operator O2 is selected but the cognitive agent business rules system 116 does not know how to apply the selected second operator O2 in the state S1. Various types of impasses are created including the tie impasse, the conflict impasse, the constraint-failure impasse and the no-change impasse (as described above in the detailed description of FIG. 2B). Going further, as discussed above, the cognitive agent business rules system 116 handles the impasse due to no operator selection for the state S1 by creating a new substate or subgoal S2 for resolving the impasse. Moreover, the type of the impasse encountered or associated with the substate S2 is the no-change impasse. In an embodiment of the present disclosure, the no-change impasse corresponds to no operator selection during the decision procedure.

In an embodiment of the present disclosure, the state S1 acts as a superstate for the substate S2. In an embodiment of the present disclosure, the substate S2 is linked directly or indirectly to the state S1. Going further, the substate S2 is associated with, for example, a fourth operator O4, a fifth operator O5 and a sixth operator O6. The cognitive agent business rules system 116 automatically detects whether the preference or the working memory elements created in the substate S2 is linked to the state S1. The working elements and the preferences linked with the state S1 are not removed if the impasse (the no-change impasse) is resolved (as described above in the detailed description of FIG. 2B).

Furthermore, the cognitive agent business rules system 116 does not select an operator of the fourth operator O4, the fifth operator O5 and the sixth operator O6 for the execution of the business rule. In an embodiment of the present disclosure, no operator is selected for the state S2. The no operator selection leads to another impasse event. In addition, the cognitive agent business rules system 116 creates a new substate or subgoal S3 for resolving the impasse arised due to the state S2. Moreover, the type of the impasse encountered or associated with the substate S3 is the tie impasse. In an embodiment of the present disclosure, the tie impasse takes place if the preferences do not distinguish between two or more operators with acceptable preferences (as described above in the detailed description of FIG. 2B).

In an embodiment of the present disclosure, the substate S2 acts as a superstate for the substate S3. In an embodiment of the present disclosure, the substate S3 is linked directly or indirectly to the substate S2. Going further, the substate S3 is associated with, for example, a seventh operator O7, an eighth operator O8 and a ninth operator O9. Moreover, the fourth operator O4, the fifth operator O5 and the sixth operator O6 act as items for the substate S3. The cognitive agent business rules system 116 automatically detects whether the preference or the working memory elements created in the substate S3 is linked to the substate S2. The working elements and the preferences linked with the substate S2 are not removed if the impasse (the tie impasse) is resolved (as described above in the detailed description of FIG. 2B).

Going further, the substate S3 is created due to the no operator selection by the cognitive agent business rules system 116 for the substate S2. Moreover, the cognitive agent business rules system 116 selects the ninth operator O9 for executing the business rule.

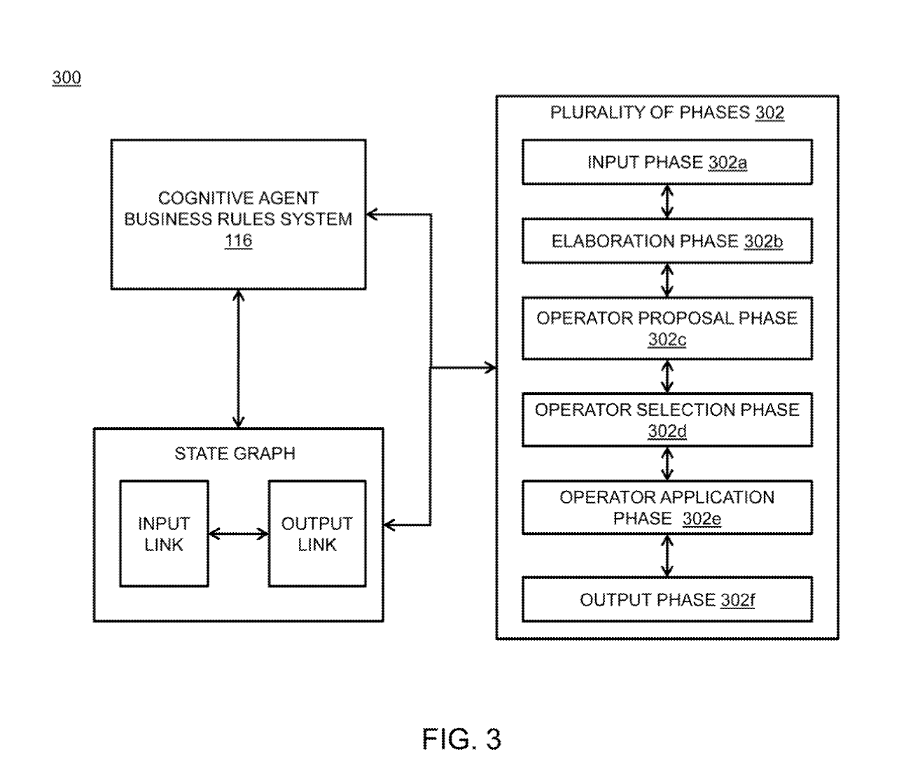

FIG. 3 illustrates a system 300 for showing various phases associated with the cognitive agent business rules system 116, in accordance with the various embodiment of the present disclosure. The block diagram 300 includes the cognitive agent business rules system 116 associated with a plurality of phases 302. In an embodiment of the present disclosure, the cognitive agent business rules system 116 includes the plurality of phases 302. Going further, the plurality of phases 302 includes an input phase 302a, an elaboration phase 302b, an operator proposal phase 302c, an operator selection phase 302d, an operator application phase 302e and an output phase 302f. Furthermore, the cognitive agent business rules system 116 is associated with the state graph. In an embodiment of the present disclosure, the cognitive agent business rules system 116 executes the plurality of business rules 208 by creating the state graph. In addition, the state graph includes the creation of the state object. In an embodiment of the present disclosure, the state object includes the input link and the output link.

Furthermore, the plurality of phases 302 helps the cognitive agent business rules system 116 in selecting the best operation for a given process corresponding to a particular business rule of the plurality of business rules 208. In addition, the input phase 302a helps in adding one or more items to the input link. In an embodiment of the present disclosure, the one or more items are added to the top level state for the creation of the state graph. In an embodiment of the present disclosure, the state graph is created for the execution of the business rules of the plurality of business rules 208. The cognitive agent business rules system 116 scans the one or more items added to the input link during the input phase 302a. In an embodiment of the present disclosure, the cognitive agent business rules system 116 scans the elements added to the working memory via the input link during the input phase 302a. The elaboration phase 302b runs the business rules and adds elaborations or deduced facts to the created state graph.

Moreover, the operator proposal phase 302c helps the cognitive agent business rules system 116 in proposing a plurality of operators for the execution of the business rule of the plurality of business rules 208. The cognitive agent business rules system 116 utilizes a two stage process for the plurality of operators. The operator selection phase 302d selects an operator of the plurality of operators proposed during the operator proposal phase 302c. The selection is based on the operator selection preference strategy for selecting the best operator for the execution of the business rule of the plurality of business rules 208 (as exemplary stated above in the detailed description of FIG. 2A).

In addition, the operator application phase 302e runs the selected operator of the proposed plurality of operators and applies the changes in the state of the state graph. Furthermore, the output phase 302f makes the changes in the output link. In an embodiment of the present disclosure, the cognitive agent business rules system 116 writes to the output during the output phase 302f. Moreover, the plurality of operators proposed during the operator proposal phase 302c run and make changes to the state or the output link leading to the execution of the business rule of the plurality of business rules 208.

In an embodiment of the present disclosure, the plurality of phases 302 loop continuously until the problem is solved. In another embodiment of the present disclosure, the plurality of phases 302 runs for a specific number of cycles. In yet another embodiment of the present disclosure, the plurality of phases 302 run only once and then stops.

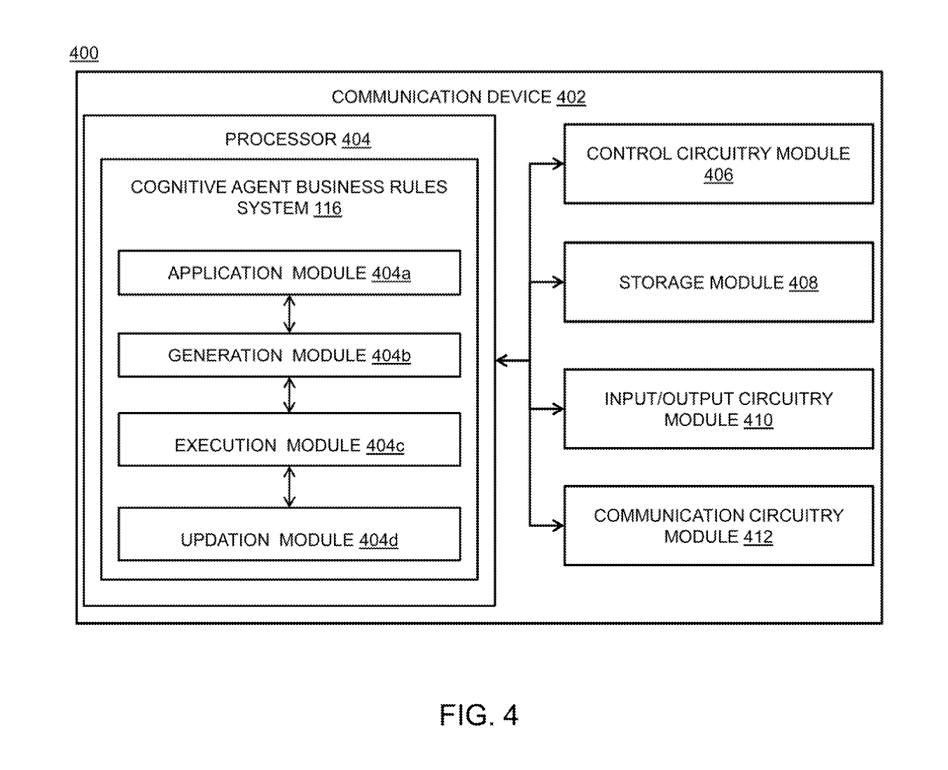

FIG. 4 illustrates a block diagram 400 of a communication device 402, in accordance with various embodiments of the present disclosure. The communication device 402 includes a processor 404, a control circuitry module 406, a storage module 408, an input/output circuitry module 410 and a communication circuitry module 412. The processor 404 runs the cognitive agent business rules system 116. Further, the cognitive agent business rules system 116 includes an application module 404a, a generation module 404b, an execution module 404c and an updation module 404d. The above stated components of the processor 404 enable working of the cognitive agent business rules system 116.

The application module 404a applies the plurality of operations to the initialized state. The state is the top level object. The generation module 404b creates the state graph. The state graph is created by adding the plurality of nodes and the plurality of attributes to the top level state. Further, the generation module 404b adds the input link to the initialized state. The input link allows the plurality of users to add the one or more elements to the working memory. Furthermore, the generation module 404b adds the output link to the initialized state. The output link allows the plurality of business rules to add the one or more elements to the output memory. The execution module 404c executes the plurality of business rules based on the adding of the plurality of nodes and the plurality of attributes to the top level state. The updation module 404d updates the state graph. The state graph is updated to reflect the new state of the state graph.

The communication device 402 includes any suitable type of portable electronic device. Examples of the communication device 402 include but may not be limited to a high end laptop computer, a tablet computer, desktop computer, and a server having computational capabilities.

From the perspective of this disclosure, the control circuitry module 406 includes any processing circuitry or processor operative to control the operations and performance of the communication device 402. For example, the control circuitry module 406 may be used to run operating system applications, firmware applications, media playback applications, media editing applications, or any other application. In an embodiment, the control circuitry module 406 drives a display and process inputs received from a user interface.

From the perspective of this disclosure, the storage module 408 includes one or more storage mediums including a hard-drive, solid state drive, flash memory, permanent memory such as ROM, any other suitable type of storage component, or any combination thereof. The storage module 408 may store, for example, media data (e.g., music and video files), application data (e.g., for implementing functions on the communication device 402).

From the perspective of this disclosure, the I/O circuitry module 410 may be operative to convert (and encode/decode, if necessary) analog signals and other signals into digital data. In an embodiment, the I/O circuitry module 410 may also convert the digital data into any other type of signal and vice-versa. For example, the I/O circuitry module 410 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 406, the storage module 408 or any other component of the communication device 402.

From the perspective of this disclosure, the I/O circuitry module 410 may be operative to convert (and encode/decode, if necessary) analog signals and other signals into digital data. In an embodiment, the I/O circuitry module 410 may also convert the digital data into any other type of signal and vice-versa. For example, the I/O circuitry module 410 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 406, the storage module 408 or any other component of the communication device 402.

From the perspective of this disclosure, the I/O circuitry module 410 may be operative to convert (and encode/decode, if necessary) analog signals and other signals into digital data. In an embodiment, the I/O circuitry module 410 may also convert the digital data into any other type of signal and vice-versa. For example, the I/O circuitry module 410 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 406, the storage module 408 or any other component of the communication device 402.

It may be noted that the I/O circuitry module 410 is illustrated in FIG. 4 as a single component of the communication device 402; however those skilled in the art would appreciate that several instances of the I/O circuitry module 410 may be included in the communication device 402.

The communication device 402 may include any suitable interface or component for allowing the plurality of users 202 to provide inputs to the I/O circuitry module 410. The communication device 402 may include any suitable input mechanism. Examples of the input mechanism include but may not be limited to a button, keypad, dial, a click wheel, and a touch screen. In an embodiment, the communication device 402 may include a capacitive sensing mechanism, or a multi-touch capacitive sensing mechanism.

In an embodiment, the communication device 402 may include specialized output circuitry associated with output devices such as, for example, one or more audio outputs. The audio output may include one or more speakers built into the communication device 402, or an audio component that may be remotely coupled to the communication device 402.

The one or more speakers can be mono speakers, stereo speakers, or a combination of both. The audio component can be a headset, headphones or ear buds that may be coupled to the communication device 402 with a wire or wirelessly.

In an embodiment, the I/O circuitry module 410 may include display circuitry for providing a display visible to the user 102. For example, the display circuitry may include a screen (e.g., an LCD screen) that is incorporated in the communication device 402.

The display circuitry may include a movable display or a projecting system for providing a display of content on a surface remote from the communication device 402 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 406. Alternatively, the display circuitry may be operative to provide instructions to a remote display.

In addition, the communication device 402 includes the communication circuitry module 412. The communication circuitry module 412 may include any suitable communication circuitry operative to connect to a communication network and to transmit communications (e.g., voice or data) from the communication device 402 to other devices within the communications network. The communication circuitry module 412 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 412 may be operative to create a communications network using any suitable communications protocol. For example, the communication circuitry module 412 may create a short-range communication network using a short-range communications protocol to connect to other devices. For example, the communication circuitry module 412 may be operative to create a local communication network using the Bluetooth,® protocol to couple the communication device 402 with a Bluetooth,® headset.

It may be noted that the computing device is shown to have only one communication operation; however, those skilled in the art would appreciate that the communication device 402 may include one more instances of the communication circuitry module 412 for simultaneously performing several communication operations using different communication networks. For example, the communication device 402 may include a first instance of the communication circuitry module 412 for communicating over a cellular network, and a second instance of the communication circuitry module 412 for communicating over Wi-Fi or using Bluetooth®.

In an embodiment, the same instance of the communication circuitry module 412 may be operative to provide for communications over several communication networks. In an embodiment, the communication device 402 may be coupled a host device for data transfers, synching the communication device 402, software or firmware updates, providing performance information to a remote source (e.g., providing riding characteristics to a remote server) or performing any other suitable operation that may require the communication device 402 to be coupled to a host device. Several computing devices may be coupled to a single host device using the host device as a server. Alternatively or additionally, the communication device 402 may be coupled to the several host devices (e.g., for each of the plurality of the host devices to serve as a backup for data stored in the communication device 402).

It may be noted that in FIG. 4, various modules of the cognitive agent business rules system 116 are shown; however those skilled in the art would appreciate that the cognitive agent business rules system 116 may have more number of modules.

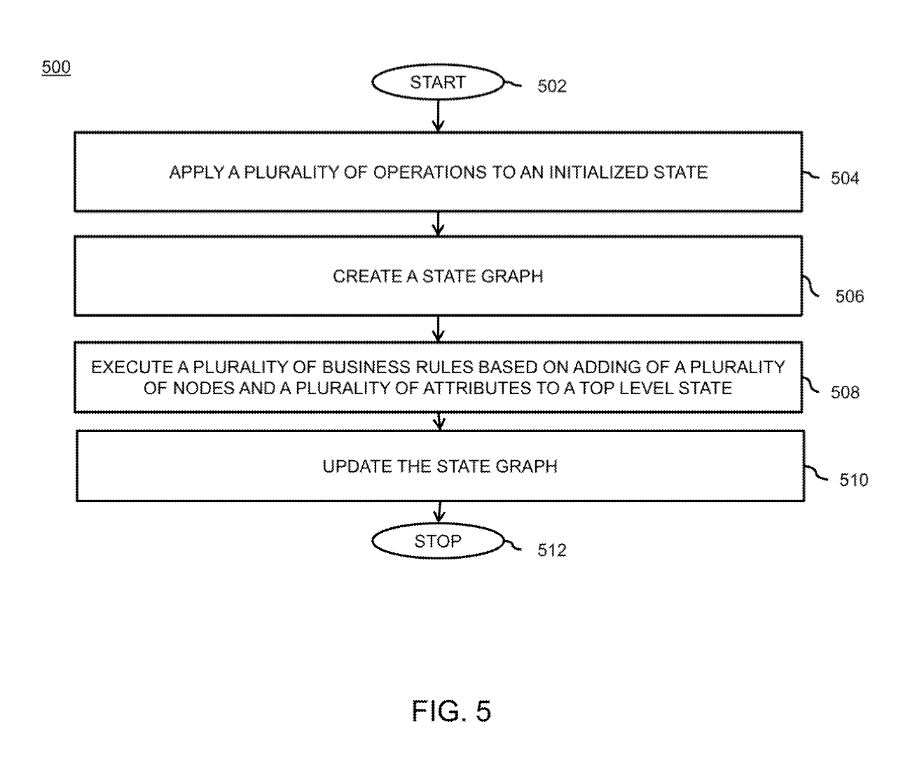

FIG. 5 is a flowchart 500 describing the execution of the plurality of business rules by the cognitive agent business rules system 116, in accordance with various embodiments of the present disclosure. It may be noted that to explain various process steps of FIG. 5, references will be made to the system elements of FIG. 1, FIG. 2A, FIG. 3 and FIG. 4. The flowchart 500 initiates at step 502. Following step 502, at step 504, the cognitive agent business rules system 116 applies the plurality of operations to the initialized state. The state is the top level object. At step 506, the cognitive agent business rules system 116 creates the state graph. The state graph is created by adding the plurality of nodes and the plurality of attributes to the top level state. At step 508, the cognitive agent business rules system 116 executes the plurality of business rules based on the adding of the plurality of nodes and the plurality of attributes to the top level state. At step 510, the cognitive agent business rules system 116 updates the state graph is updated to reflect the new state of the state graph. The flowchart 500 terminates at step 512.

It may be noted that the flowchart 500 is explained to have above stated process steps; however, those skilled in the art would appreciate that the flowchart 500 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method comprising:
applying, with a processor, a plurality of operations to an initialized state, wherein the state being a top level object;
creating, with the processor, a state graph, wherein the state graph being created by adding a plurality of nodes and a plurality of attributes to a top level state;
executing, with the processor, a plurality of business rules based on the adding of the plurality of nodes and the plurality of attributes to the top level state; and
updating, with the processor, the state graph, wherein the state graph is updated to reflect a new state of the state graph,
wherein the applying, the creating, the executing and the updating being performed through a plurality of phases.

2. The computer-implemented method as claimed in claim 1, further comprising adding, with the processor, an input link to the initialized state, wherein the input link being configured to allow a plurality of users to add one or more elements to a working memory.

3. The computer-implemented method as claimed in claim 1, further comprising adding, with the processor, an output link to the initialized state, wherein the output link being configured to allow plurality of business rules to add one or more elements to an output memory.

4. The computer-implemented method as claimed in claim 1, wherein the plurality of phases comprises an input phase, an elaboration phase, an operator proposal phase, an operator selection phase, an operator application phase and an output phase.

5. The computer-implemented method as claimed in claim 1, wherein one or more variables being bound to one or more symbols in corresponding one or more elements of a working memory to obtain a production.

6. The computer-implemented method as claimed in claim 5, wherein an action of the production creates a plurality of preferences for selecting one or more operators, wherein each of the plurality of preferences comprises a corresponding semantic of a plurality of semantics, and wherein the plurality of preferences comprises at least one of an acceptable preference, a reject preference, a better/worse preference, a best preference, a worst preference, an indifferent preference, a numeric-indifferent preference, a require preference and a prohibit preference.

7. The computer-implemented method as claimed in claim 6, wherein a plurality of impasses arises from the plurality of preferences, wherein the plurality of impasses comprises a tie impasse, a conflict impasse, a constraint-failure impasse and a no-change impasse, wherein the no-change impasse further comprises a state no-change impasse and an operator no-change impasse.

8. The computer-implemented method as claimed in claim 5, wherein an action of the production adds one or more elements in a working memory, and wherein the one or more elements being added from at least one of a plurality of sources.

9. The computer-implemented method as claimed in claim 5, wherein an action of the production removes one or more elements from a working memory, and wherein the one or more elements being removed by at least one of a plurality of removal ways.

10. A computer program product comprising a non-transitory computer readable medium storing a computer readable program, wherein the computer readable program when executed on a computer causes the computer to perform steps comprising:
applying a plurality of operations to an initialized state, wherein the state being a top level object;
creating a state graph, wherein the state graph being created by adding a plurality of nodes and a plurality of attributes to a top level state;
executing a plurality of business rules based on the adding of the plurality of nodes and the plurality of attributes to the top level state; and
updating the state graph, wherein the state graph is updated to reflect a new state of the state graph,
wherein the applying, the creating, the executing and the updating being performed through a plurality of phases.

11. The computer program product as claimed in claim 10, wherein the computer readable program when executed on the computer causes the computer to perform a further step of adding an input link to the initialized state, wherein the input link being configured to allow a plurality of users to add one or more elements to a working memory.

12. The computer program product as claimed in claim 10, wherein the computer readable program when executed on the computer causes the computer to perform a further step of adding an output link to the initialized state, wherein the output link being configured to allow a plurality of business rules to add one or more elements to an output memory.

13. A cognitive agent business rules system comprising:
an application module, in a processor, wherein the application module being configured to apply a plurality of operations to an initialized state, wherein the state being a top level object;
a generation module, in the processor, wherein the generation module being configured to create a state graph, wherein the state graph being created by adding a plurality of nodes and a plurality of attributes to a top level state;
an execution module, in the processor, wherein the execution module being configured to execute a plurality of business rules based on the adding of the plurality of nodes and the plurality of attributes to the top level state; and
an updation module, in the processor, wherein the updation module being configured to update the state graph, wherein the state graph is updated to reflect a new state of the state graph.

14. The cognitive agent business rules system as claimed in claim 13, wherein the generation module, in the processor, being further configured to add an input link to the initialized state, wherein the input link being configured to allow a plurality of users to add one or more elements to a working memory.

15. The cognitive agent business rules system as claimed in claim 13, wherein the generation module, in the processor, being further configured to add an output link to the initialized state, wherein the output link being configured to allow a plurality of business rules to add one or more elements to an output memory.

16. The cognitive agent business rules system as claimed in claim 13, wherein the cognitive agent business rules system comprises a Soar component.

17. The cognitive agent business rules system as claimed in claim 16, wherein the Soar component comprises one or more views, wherein the one or more views comprises at least one of a trace view, a production view and a goal stack view.

18. The cognitive agent business rules system as claimed in claim 16, wherein the Soar component handles one or more events by utilizing SoarEventManager and SoarEventListener interfaces.

19. The cognitive agent business rules system as claimed in claim 13, wherein one or more variables being bound to one or more symbols in corresponding one or more elements of a working memory to obtain a production.

20. The cognitive agent business rules system as claimed in claim 19, wherein an action of the production creates a plurality of preferences for selecting one or more operators, wherein each of the plurality of preferences comprises a corresponding semantic of a plurality of semantics, and wherein the plurality of preferences comprises at least one of an acceptable preference, a reject preference, a better preference, a best preference, a worst preference, an indifferent preference, a numeric-indifferent preference, a require preference and a prohibit preference.
